(19) United States
(12) Patent Application Publication
(10) Pub. No.: US 2008/0126357 A1
(43) Pub. Date: May 29, 2008

(54) DISTRIBUTED FILE STORAGE AND TRANSMISSION SYSTEM

(75) Inventors: Xavier Casanova, San Jose, CA (US); Guillaume Thonier, Sunnyvale, CA (US); Arnaud Tellier, Sunnyvale, CA (US)

Correspondence Address: ROBERT M. MCDERMOTT, ESQ., 1824 FEDERAL FARM ROAD, MONTROSS, VA, 22520, US

(73) Assignee: Wambo, Inc., Sunnyvale, CA (US)

(21) Appl. No.: 11/743,637

(22) Filed: May 2, 2007

Related U.S. Application Data
(60) Provisional application No. 60/797,573, filed on May 4, 2006.
(60) Provisional application No. 60/797,574, filed on May 4, 2006.
(60) Provisional application No. 60/797,575, filed on May 4, 2006.

(51) Int. Cl. G06F 17/30

(52) U.S. Cl. 707/10; 707/E17.032

(57) ABSTRACT

A distributed file storage and communication system stores redundant copies of segments of a file on multiple remote storage units. The file to be stored is partitioned into multiple fragments, and each of the fragments is redundantly stored on multiple remote storage units. A file tracker is maintained that identifies where each fragment is stored. Providing the file tracker to another user allows the other user to access the file. To receive and/or retrieve the file, the system retrieves each fragment by attempting to download the fragment from one of the remote storage units identified in the file tracker for the fragment; if the selected remote storage unit is not available, another storage unit is selected for attempting the download. The selection of storage units to receive each fragment may be random or targeted, or a combination of both. Preferably, each fragment is encrypted, and the intended recipient is provided a key to decrypt the fragments.

This application claims the benefit of U.S. Provisional Patent Applications 60/797,573, 60/797,574, and 60/797,575, each filed on 4 May 2006.

### BACKGROUND AND SUMMARY OF THE INVENTION

This invention relates to the field of data management, and in particular to a method and system for storing data redundantly on a plurality of distributed storage units. This method and system may also be used to indirectly transmit the data to intended recipients.

The cost of storage devices continues to decrease, while the need to securely store and/or reliably communicate data continues to increase. The need for security includes both security from unauthorized access to the data and security from loss of the data. The need for reliable communication includes reliability using conventional communication channels.

It would be advantageous to provide a secure data storage scheme that also facilitates reliable communication of the data.

In the field of data storage, this invention addresses a method and architecture that facilitates reliable access to a user's file system regardless of the particular location/access-point of the user.

As the mobility of computer users continues to expand, the need for each user to access his/her files while at remote locations increases. Conventionally, the user transports the files onto a portable computer or portable memory device, and travels with the portable device.

Alternatively, the user may place the files on a remote storage device that is accessible via a network connection, such as a computer/server that is remotely accessible via a telephone or Internet connection. The computer can be, for example, the user's home or office computer that is configured for remote access. When the user requires a file at a remote station, the user accesses the home or office computer via a telephone or Internet connection, then downloads the file to the remote station. This option requires that the user's home or office computer is available on-demand while the user is away from the home or office, which may not always be practical or feasible. If the home or office computer is unattended, and a power interruption or system hang-up occurs, it will generally remain unavailable until someone physically restarts the system, or otherwise corrects the problem.

Alternatively, the computer/server can be a commercial web-site that is configured to provide remotely accessible storage for their clients/customers. To be commercially viable, however, such a web-site must provide sufficient storage capabilities, and sufficient bandwidth, to satisfy the demands of the clients, and as the success of the web-site increases, the demands placed on the site also increases. Additionally, to provide reliable service, the storage provider is likely to store redundant copies of the clients' data, thereby doubling or tripling its required storage capacity.

Remote storage is also desirable for individual back-up security. In this case, the user may not travel, but may desire that a copy of the user's data be stored at a remote site, in the event that the user's environment experiences catastrophic loss or damage from fire, flood, theft, and so on. Although backup providers may not require a significant amount of bandwidth, because the number of simultaneous retrieval demands may be slight, and incremental storage updates can be provided, the backup provider must provide a sufficient amount of storage to assure reliable service, including the aforementioned storage redundancy.

Although a remote backup scheme could be used to communicate files, whereby a first user sends a file to the backup server and a second user retrieves the file from the backup server, providing the second user access to the first user's backup storage would conventionally enable the second user to access any and all of the files on the first user's backup storage. To provide a controlled access, the first user would need to set up a different backup storage for each potential recipient and selectively control where each file is backed up, or would need to encrypt each file differently and provide a select decryption key to the intended recipient.

It would be advantageous to provide a combined data storage and data communication scheme that includes a unique access control for each remotely-accessible stored file, whereby the intended recipients of a particular file can be provided the unique access control for that file.

Another issue and/or concern that is inherent in the use of remote data servers is the reliability and availability of the data server, as well as the communication channel to the remote data server. Preferably, the data server is continuously available, and redundant storage and access is provided to accommodate scheduled and unscheduled outages. If multiple users are provided access to the data server, the bandwidth of the communication channel to the data server will be shared among the multiple users. If the stored file is large, special purpose programs are generally used to enable segmented uploads or downloads, with defined restart points that facilitate restartable uploads or downloads when breaks occur in the transmission.

It would be advantageous to provide a communication channel for stored data that is not dependent on a single data server or a single communication channel.

These advantages, and others, can be realized by a distributed file storage and communication system that stores redundant copies of segments of a file on multiple remote storage units. The file to be stored is partitioned into multiple fragments, and each of the fragments is redundantly stored on multiple remote storage units. A file tracker is maintained that identifies where each fragment is stored. Providing the file tracker to another user allows the other user to access the file. To receive and/or retrieve the file, the system retrieves each fragment by attempting to download the fragment from one of the remote storage units identified in the file tracker for the fragment; if the selected remote storage unit is not available, another storage unit is selected for attempting the download. The selection of storage units to receive each fragment may be random or targeted, or a combination of both. Preferably, each fragment is encrypted, and the intended recipient is provided a key to decrypt the fragments.

### BRIEF DESCRIPTION OF THE DRAWINGS

The invention is explained in further detail, and by way of example, with reference to the accompanying drawings wherein:

FIG. 1 illustrates an example block diagram of a networked system that facilitates the redundant storage of multiple segments of a file in a typical embodiment of this invention.

FIG. 2 illustrates an example flow diagram for storing and/or transmitting a file in a typical embodiment of this invention.

FIG. 3 illustrates an example flow diagram for retrieving and/or receiving a file in a typical embodiment of this invention.

FIG. 4 illustrates an example block diagram of a distributed file system in a typical embodiment of this invention.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

The invention addresses and solves a number of different issues related to data storage and data communication, each of which may or may not be applicable in a given situation. That is, although the invention addresses requirements related to both data storage and data communications, the principles of this invention can be applied to either a data storage system or a data communication system, or a combination of both.

The distributed file system of this invention operates by partitioning a file into a plurality of fragments, preferably encrypting each fragment, and storing the fragments at a plurality of remote nodes in a network. To assure reliability, each fragment is redundantly stored at a plurality of nodes.

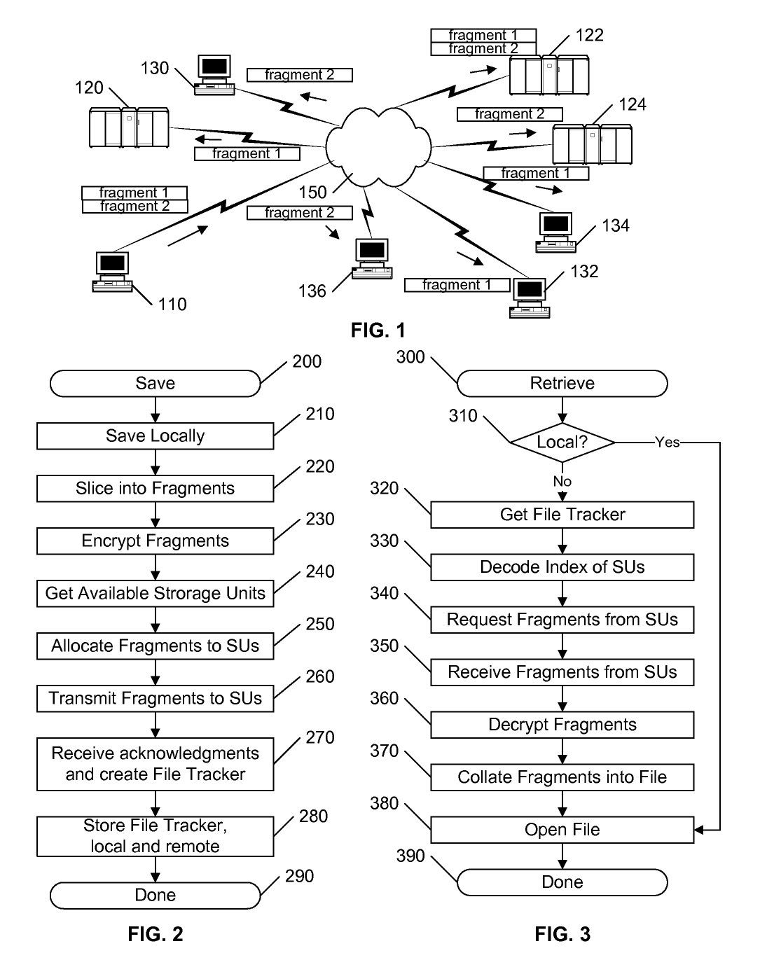

FIG. 1 illustrates an example block diagram of a networked system 150 that facilitates the redundant storage of multiple fragments of a file in accordance with this invention.

A user of device 110 initiates a request to save or transmit a file. In response to the request, the device 110 partitions the file into a plurality of fragments. FIG. 1 illustrates two fragments, fragment1 and fragment2, although typically most files will be partitioned into a greater number of fragments. The device 110 then transmits the fragments to a variety of remote storage nodes 120, 122, 124, 130, 132, and so on. The storage nodes may be conventional data servers, such as illustrated by nodes 120, 122, or 124, or individual computers, such as illustrated by nodes 130, 132, 134, and 136. Each fragment is communicated to a plurality of devices; for example, fragment1 is sent to storage nodes 120, 122, 132, and 134, and fragment2 is sent to storage nodes 122, 124, 130, and 136. As illustrated in this example, all, some, or none of the fragments of a file may be stored at each storage node. To retrieve and/or receive the file, a receiving device downloads fragment1 from one of storage nodes 120, 122, 132, or 134, and fragment2 from one of the storage nodes 122, 124, 130, or 136, then reconstructs the file from these fragments. Each of the storage nodes may have more or less storage capacity allocated to the storage of data from other nodes; and, to facilitate the allocation and management of storage capacity, the term ‘storage unit’ is used herein to identify discretely identifiable addressable storage areas. That is, a request to store a data element to a referenced storage unit will correspondingly provide a means for retrieving the data element from the referenced storage unit. Each storage node 120-136 may provide one or more storage units.

To facilitate this distributed storage, a file tracker is maintained for each saved file. This file tracker includes an identifier of the storage units at which each redundant copy of each encrypted fragment has been stored. The file tracker is preferably encoded using hashing and other techniques, to minimize the size of the tracker associated with each file. To facilitate remote access to the file, the file tracker is preferably also stored at a central repository. To assure security, the file tracker is optionally stored in an encrypted form, or, access to the file tracker is restricted using conventional restricted-access techniques.

FIG. 2 illustrates an example flow diagram for the storage of a file in a typical embodiment of this invention.

At 200, the user initiates a command to save or transmit a file. At 210, the file is saved locally; if the command is to only transmit the file, the storage of the file may be temporary, or omitted entirely.

At 220, the file is segmented into fragments. The size of each fragment is generally a design parameter that is dependent upon a tradeoff between potential wasted storage space and the overhead associated with managing the segmented file. That is, if a larger fragment size is used, each file will have fewer fragments, but more space will be lost when the last fragment is smaller than the allocated fragment size. The fragmentation may be fixed or dependent on attributes of the file being saved; for example, large files may use a larger default fragment size. To facilitate the use of different fragment sizes, each different size is preferably a multiple of the smallest fragment size, so that the allocation of storage units to a larger fragment merely amounts to an allocation of multiple contiguous (logically or physically) storage units that are referenced by the first storage unit.

To reduce storage requirements, the file and/or the fragments may be compacted, using conventional compaction techniques. Preferably, the file is compacted prior to segmentation, thereby allowing for fragments of consistent size, which generally simplifies the storage process at the storage units.

Optionally, each fragment is encrypted, at 230. Preferably, the method and system of invention provides for secure storage of each file; however, the degree of security may vary, depending upon the particular file being saved or transmitted. If a user is storing or transmitting a financial file, for example, each fragment will preferably be encrypted. On the other hand, if the user is storing or transmitting a photograph, the segmentation of the photograph into fragments may provide a sufficient degree of privacy, because the association of individual fragments to particular files is only explicitly known from the file tracker. A hacker may be able to assemble the distributed fragments as a jigsaw puzzle to recreate the files, but the likelihood of such hacking merely to discover a photograph will be slight and/or inconsequential.

At 240, a set of available storage units for the fragments is determined. Any of a variety of techniques can be used to create such a state. In a centralized scheme, a central server can be configured to keep track of available storage units, and each user's device can be configured to contact the central server to obtain the set. The allocation of fragments to storage units, at 250, may be performed at either the central server or the user's device. As an alternative to the use of a central server, the user device 110 may be configured to query a plurality of nodes on a network to determine which nodes are available for providing storage units. The number of storage units allocated to receive each fragment is determined based on the particular data being stored and the likelihood of the storage units being available when the file needs to be retrieved. If the storage units are on servers that are generally continuously available on the Internet, or within a corporate network, for example, as few as two or three storage units per fragment may be deemed sufficient. If, as discussed further below, the storage units are storage devices of an ad-hoc collection of users who are likely to be available on the Internet, but not required to be available, as many as ten storage units per fragment may be deemed necessary. In like manner, if the data is of critical importance, the number of storage units per fragment may double or triple, whereas if it is relatively unimportant, or easily recoverable by other means, the number of storage units per fragment may be reduced by half or more. Similarly, if the data storage is being used as a communication medium rather than as permanent storage, and the original data is secured elsewhere, the number of storage units per fragment may be reduced as well.

At 260, the fragments are stored at the assigned storage units. Preferably, the replication of each fragment is provided in a distributed manner. The originating node, for example, sends the fragment to a second node, with an identifier of the other N−1 nodes that are also to receive the fragment. The second node stores the fragment and also transmits the fragment to a third node, selected from the list of N−1 nodes, along with a list of the N−2 remaining nodes. The third node stores the fragment, and transmits the fragment to a fourth node, selected from the list of N−2 nodes, along with a list of the N−3 remaining nodes. This process continues until each of the N redundant nodes receives the fragment. Procedures are provided to assure that each of the N nodes has successfully stored the fragments. For example, the instruction to store the fragment may include the address of the originating node, and each node may be configured to inform the originating node that it has stored the fragment. If, after a given time period, the originating node does not receive the confirmation, the originating node may allocate a replacement storage unit for each of the non-responding storage units in the original allocation. The fragment is sent to the replacement set of storage units, and the above process is repeated until the originating node receives confirmation from a given number of storage units for each of the fragments.

At 270, the originating node creates a file tracker that identifies where each of the fragments of the file are stored. The form of the file tracker may vary, depending upon the addressing scheme used to identify the storage units.

In a system that uses a centralized control structure, the centralized server may maintain an indexed list of addresses of storage units, and the identification of each storage unit may merely be references to this list. This list of addresses may be provided to each of the nodes that use this centralized service, to enable retrieval of the fragments by each node, or, the centralized server may be configured to receive a list of references and provide a corresponding list of addresses on demand.

In another embodiment, each storage node can be configured to maintain an indexed list of storage units at the node, and to provide a reference to this list to the originating node when it acknowledges receipt and storage of the fragment at the corresponding storage unit. Note that the term ‘indexed list’ is used in its broadest sense to include any addressing scheme wherein data can be retrieved by providing a reference to the address space of a storage element that contains the data. For example, in a direct-address memory, the most significant bits of the memory address can be used as an indexed list of memory locations; in an indirect-addressing scheme, such as a file-based system, the individual file names form the indexed list of memory locations; and so on.

A mix of addressing schemes may also be used. In the above example embodiments, for example, the centralized server may be configured to provide a reference to the storage nodes, and each storage node could be configured to provide a reference to the storage unit with the storage node, such that the address of the storage unit is formed as a concatenation of the two references.

In like manner, other methods of referencing storage units may be devised using techniques common in the art. Preferably, the addressing scheme will be a balance between the desire to keep the file tracker to a relatively small size, and the desire to minimize the complexity required to retrieve the fragments. To provide a self-contained file tracker that does not require access to an external list, for example, the file tracker may include a header block that identifies each of the storage nodes by their URL, and the identification of the storage units for each fragment will include a reference to the corresponding node in the header and the reference to the storage unit at the node. Note that in this example, each originating node may provide the URLs of the storage nodes that it accesses for storage, and a centralized control scheme is not required.

One of skill in the art will recognize that the structure of the file tracker described above is merely an example, and other means for managing the storage and retrieval of fragments at remote nodes may be used. For example, the size of each storage unit can be very large, so that the total number of storage units is within some bound that allows for fewer bits to uniquely identify each storage unit. That is, in a system that has a total storage capacity of 2^{M} bytes, and each storage unit comprises 2^{N} bytes, there will be a maximum of 2^{M-N} storage units. In such a system, the minimum number of bits required to uniquely address each storage unit is equal to M-N. Thus, by increasing the size of each storage unit, N increases and the number of bits needed for each reference in the file tracker, M-N, decreases.

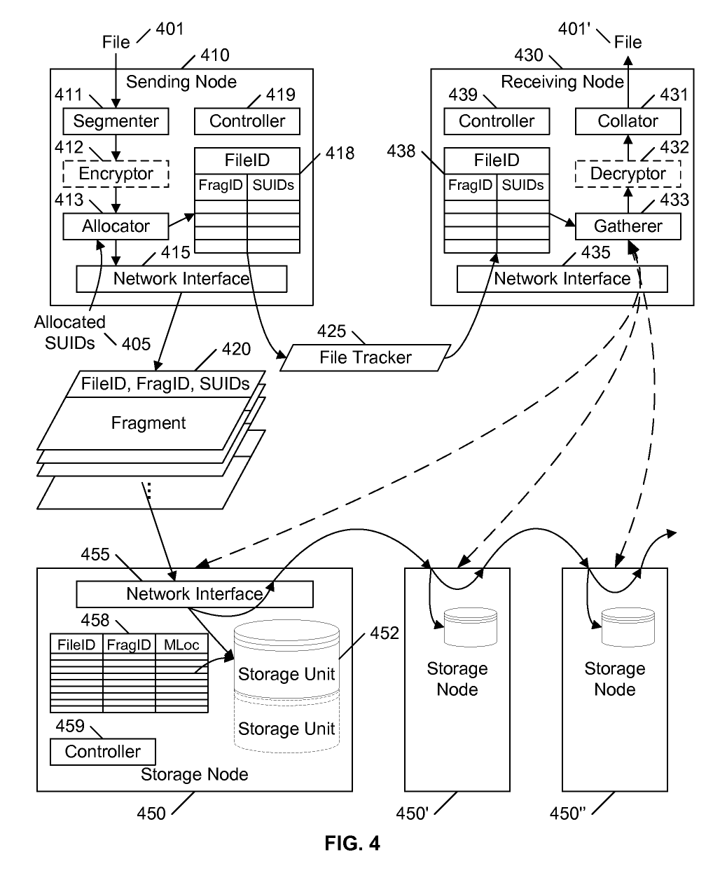

If each storage unit is configured to manage the allocation of space for each received or requested fragment, the file tracker need only identify the (very large) storage unit. At the storage node, a map is maintained that maps each file and fragment pair to a particular memory location, as illustrated at 453 of FIG. 4, discussed further below. That is, for example, if the file tracker only contains a (short) reference to a (very large) storage unit, to minimize the size of the file tracker, the storage and retrieval processes will be configured to send an identifier of the file and an identifier of the fragment to the storage unit identified in the file tracker for this fragment. Upon receipt of the file and fragment identifier pair, the storage node accesses its storage map to determine the corresponding address within the storage unit that is used to store the fragment.

In an example embodiment of this invention, the size of each fragment is 512 KB, the size of each storage unit is 500 MB, and 32 bits are used to identify each storage unit, allowing for over four billion different storage units. Thus, a typical 2 MB picture image file would be segmented into four fragments, and, assuming that the fragments are replicated to five storage units, each fragment index will use twenty bytes. Thus, in this example, the amount of data in the file tracker to identify the storage locations of the fragments will amount to fewer than 100 bytes. Other data, such as revision data, may also be included in the file tracker, as discussed further herein.

To further reduce the size of the file tracker, other conventional data compaction techniques may be used, including, for example, hashing each reference to a storage unit, hashing each set of references for each fragment, and so on. In like manner, the entries in the file tracker may be encoded using common coding schemes that provide compaction, such as a Huffman encoding scheme that replaces commonly repeated data sequences with shorter codes. These and other common techniques for optimizing information content will be evident to one of ordinary skill in the art.

At 280, the file tracker is stored and/or transmitted to an intended recipient of the file. Preferably, the file tracker is also stored at a remote site that is accessible to the originator and/or the recipient, in the event that the locally stored or transmitted file tracker is lost or otherwise becomes inaccessible. The file tracker will generally include a header that contains information that facilitates the storage and retrieval of the stored data, including, for example, the fragment size used to segment the file, as discussed above with respect to block 220.

At 290, the saving process is terminated. Preferably, this saving process, or transmission process, is initiated and terminates in the same manner as a conventional save or transmit command. That is, the fact that the file is distributed among a number of remote storage units should be transparent to the user.

An example flow diagram for the typical retrieval process is illustrated in FIG. 3.

The user initiates the process at 300, preferably by ‘clicking on’ an icon or hypertext corresponding to the file tracker, which causes the retrieval application process to start, or by explicitly starting the retrieval application and then selecting the file tracker. Preferably, the file tracker appears and is acted upon in the same manner as the actual file; that is, the fact that the icon or filename corresponds to a file tracker instead of the actual file should be transparent to the user.

The retrieval application determines whether the actual file is already present at the local node, at 310, and if so, merely opens the file in the conventional manner, at 380, including invoking, for example, a corresponding word processing program if the file is a text document, an image viewer if the file is a picture, a video player if the file is a movie, and so on.

If the actual file is not present at the local node, the file tracker is opened and read. The file tracker may be opened directly at the local node, or it may be downloaded from a remote site. That is, the aforementioned icon or filename that references the file tracker may represent a ‘shortcut’ or hypertext element that corresponds to an address of the file tracker, instead of the file tracker itself.

At 330, the file tracker is decoded to determine the storage units associated with each fragment. This decoding will be dependent upon the particular addressing and tracking scheme used, as discussed above with regard to block 270 of FIG. 2. One of skill in the art will recognize that the decoding process is typically an inversion of the processes applied during the encoding process.

At 340, each fragment is requested from one of the storage units allocated to the fragment, and received at 350. The particular scheme used for requesting the fragments will be dependent upon the particular storage scheme used. If all of the storage units are located on a few storage nodes, the storage nodes may initially be queried to determine which nodes are available and/or which nodes have the widest available bandwidth for downloading the fragments. Thereafter, the selection of which storage unit to use for requesting each fragment will be dependent upon this initial availability determination. Alternatively, the first listed storage unit for each fragment may be used, or a randomly selected storage unit. If the selected storage unit is not available, another storage unit is selected until the fragment is successfully downloaded. If no storage unit is available for downloading the fragment, an appropriate error message is communicated to the user.

If the fragments were encrypted, at 230 of FIG. 2, they are correspondingly decrypted, at 360. When all the fragments are received and appropriately decrypted, they are collated to recreate the original file. Conventional techniques are used for identifying the proper sequence of fragments, the simplest of which is to use the order of fragments in the file tracker as the proper order for collating the received fragments. Optionally, each fragment may include a header field that contains a sequence number of the fragment.

When the file is formed, or as it is forming, the appropriate application program corresponding to the file type is invoked to render the file, at 380, as noted above. The retrieval process is terminated at 390. Preferably the commencement and termination of this retrieval process is similar to a conventional open or download command, so that the retrieval of the file from multiple remote storage units is virtually transparent to the user.

FIG. 4 illustrates an example block diagram of a typical embodiment of this invention. A sending node 410 is configured to send fragments of a file 401 to a plurality of storage nodes 450, 450′, 450″ using the techniques discussed above. A receiving node 430 is configured to retrieve the segments from one or more of the storage nodes 450, 450′, 450″ to create a copy 401′ of the original file 401. The sending node 410 and the receiving node 430 are illustrated as separate nodes, for ease of understanding, although generally each user's node will be both a sending and receiving node. In like manner, the storage nodes 450 are illustrated as being separate from the sending 410 and receiving 430 nodes, although typically each user's node will also be a storage node. Each node 410, 430, 450 includes a controller 419, 439, 459, respectively, that is configured to perform the operations discussed herein, typically via execution of a software program. The other illustrated items 411, 412, 413, etc. are illustrated as discrete elements for ease of understanding, although one of skill in the art will recognize that these elements may be functional components of the aforementioned software program that is executed at the controllers 419, 439, 459.

The sending node 410 includes a segmenter 411 that segments the file 401 into fragments, and an optional encrytor 412 that encrypts each segment. An allocator 413 typically receives the identification of a set of allocated storage units, SUIDs 405 from a central server (not illustrated), although each sending node could define the set directly, for example, by sending availability-queries to known storage nodes. The allocator 413 assigns multiple storage units to each fragment, and keeps track of the allocations in a tracking table 418. Based on these allocations, the controller 419 transmits each segment to one of its allocated storage units, via a network interface 415. Each fragment transmission 420 includes an identification of the file, FileID, an identification of the fragment, FragID, and a list of the storage units allocated to the fragment, SUIDs, typically in the form of a header 421 to the fragment data 422. Although FIG. 4 illustrates that all of the fragments are transmitted to storage node 450, for ease of illustration, different segment could be transmitted to different storage nodes.

The storage node 450 receives each of its assigned fragments, via its network interface 455. In this example embodiment, the storage node 450 maintains a storage map 458 for each of its storage units 452, wherein each pair of file and fragment identifiers, FileID and FragID, is mapped to a unique memory location within the storage unit 452 identified by one of the storage unit identifiers SUIDs. The fragment data 422 is subsequently stored at the designated memory location in the storage unit 452.

The storage node 450 in a preferred embodiment is also configured to relay the fragment to a storage node in the list of storage nodes SUIDs that has not yet received the fragment, if any. In a typical embodiment, the list of SUIDs contains a field that is used to mark whether each storage unit has received and stored the fragment. The storage unit 450 marks the field to signal that it has stored the fragment, and searches the field for a storage unit that has not yet received the fragment. The storage unit 450 then transmits the fragment, with the updated list of SUIDs, to the storage node 450′ that contains the storage unit that has not yet received the fragment. The storage unit 450′ receives and stores the fragment in the storage unit identified in the SUIDs, updates the field to signal that it has stored the fragment, and transmits the fragment to another storage node 450″ that contains a storage unit that has not yet received the fragment. This process continues until the fragment is transmitted to each of the assigned storage units for the fragment. Appropriate error handling is provided to accommodate the possibility that one or more of the storage units are not available, using conventional techniques such as those discussed above.

The sending node 410 creates a file tracker 425 that includes the file tracking table 418 as well as other data, such as revision data, discussed further below. To transmit the file to a receiving node, the sending node transmits the file tracker 425. As noted above, the file tracker 425 is a relatively short file, and can easily be transmitted as an attachment to an e-mail message to the receiving node 430, even though the actual file may be very large. This indirect access technique using a short file tracker instead of the actual file provides advantages to the user of the receiving node, in that it allows the user to selectively determine whether to download the large file, and avoids the problem of the user's mailbox becoming full with potentially unwanted file attachments. In a preferred embodiment, the user is provided the option of configuring the system to automatically download files upon receipt of a file tracker attachment. This option preferably allows the user to include or exclude particular senders, or classes of senders, for performing the automatic download, as well as specifying limits regarding file size, current status of the user's system, and so on.

If the receiving user wants to access the file, the receiving node extracts the information in the file tracker 425 to create a tracking table 438 that corresponds to the original tracking table 418 at the sending node 410. A gatherer component 433 is configured to download each fragment in the tracking table 418 by requesting the fragment from one of the identified storage units, SUIDs, assigned to the fragment. If the selected storage unit is not available, or is not able to send the requested fragment, the gatherer 433 selects another storage unit from the list of SUIDs for the fragment and tries again until the fragment is received from at least one of the storage units. If the fragment had been encrypted at the sending node 410, it is correspondingly decrypted by a decryptor 432 at the receiving node 430. A collator 431 arranges the fragments in their proper order and provides a copy 401′ of the original file 401.

The above outlines the general principles of this invention. One of skill in the art will recognize that a variety of embodiments and options can be provided, as detailed further below.

The storage and retrieval of the fragments, discussed above, can be accomplished sequentially or in parallel, depending upon the available downloading bandwidth from and to the originating or retrieving node. As noted above, the choice of which of the redundant storage units should be first accessed for storing or retrieving can be either random or directed. In a directed embodiment, for example, the central server that provides the identification of the available storage units can be configured to provide an indication of the likelihood that the storage unit is available, the bandwidth associated with the storage unit, and so on; or, it may provide a simple ranking of the storage units.

Preferably, the file tracker includes revision information, or the revision information is included in a version table associated with the file tracker. In this manner, the storage and retrieval process can be made more efficient by only storing or retrieving fragments that have changed. That is, the storing process will identify which fragments have changed, for example, by comparing the file to be saved to a copy of the file that was provided when the file was initially downloaded. If a fragment has not changed, the allocation of storage units to the fragment remains the same, and the saving process does not retransmit the fragment to these storage units. If a fragment has changed, the new data is transmitted to the previously allocated storage units, or to newly allocated storage units, with a corresponding change to the file tracker.

In like manner, the retrieval of segments can be optimized to retrieve only changed fragments. As noted above, in a data storage embodiment, the file is preferably stored at the local node, as well as distributed among remote nodes (see description above of 210 of FIG. 2 and 310 of FIG. 3). One of the likely uses of this invention is remote access to the distributed file, such as when a user edits and resaves the file from a remote site, or when the file is edited and resaved by another user at a remote site. When the user retrieves the edited version of the file at the local node, the system preferably only downloads the fragments that have changed, as indicated by the version numbers associated with each fragment in the local version and the distributed version.

In view of the above, one of skill in the art will recognize that conventional collaborative editing management techniques can be applied to allow the distributed file of this invention to be edited by multiple users by effectively managing the different versions of each fragment, with appropriate marking of each changed fragment.

Note that in the above descriptions, the file itself need not to be physically contiguous, and conventional techniques for managing large dynamic files, such as the use of linked lists to maintain logical contiguity independent of the physical contiguity, may be used within the file. In this manner, insertions into or deletions from a file need not require a retransmission of all the fragments following the insertion or deletion. Processes for logically structuring a file independent of its physical structure are common in the art, and may be included in the storage system of this invention, or as would be more common, included in an application that creates or edits the file.

Optionally, if the system is configured to allow ‘roll-backs’ to prior versions of the file, the changed fragments can be stored at newly allocated storage units, and the prior fragments retained in the previously allocated storage units. In an example embodiment, the file tracker will include a version number associated with each stored fragment. When the file is to be retrieved, the user has the option of defining a particular version to be retrieved, the default being the last version. The latest version of each fragment, up to and including the desired version, will be identified, and each of the fragments that do not correspond to the versions of the fragments currently on the user's device will be obtained from the storage units. At any time, the user may choose to define the current version as a ‘baseline’, and any prior versions of saved fragments will be deleted from the file tracker, and identified as being available storage units for subsequent reallocation by the centralized server, or the storage node, or both, depending upon the particular address allocation technique being used. Similarly, the user may choose to delete a file, and all of the storage units identified in the file tracker will be identified as being available storage units for subsequent reallocation, and the file tracker will be deleted.

As mentioned above, this invention provides the potential for distributed storage on devices associated with an ad-hoc collection of users, such as users who subscribe to a centralized service that coordinates this distributed storage. In a preferred embodiment of this aspect of the invention, each user agrees to provide remotely accessible storage, and a storage coordinator maintains an inventory of this user-provided storage, and manages the allocation of these storage resources among users.

Effectively, the users form a community of users who are willing to share their excess storage resources in return for the right to store their content material at other users' sites. With the cost of storage continually decreasing, and with personal and/or office computers being configured with tens or hundreds of gigabytes of storage by default, most users have a substantial amount of excess storage capacity available. Additionally, many computer users have a wideband connection to the Internet that is used relatively infrequently for ‘bursts’ of data transfers. Because the storage and bandwidth requirements are relatively insubstantial with respect to typically available resources, embodiments of this invention scale well with increasing demand. Note that the aforementioned community of users may also be formed by mandate; for example, a corporation may mandate that all corporate computers are configured to share their storage resources.

This invention allows users to share their excess storage capacity, with minimal interactions required by the users. As noted above, the save and retrieve processes are preferably transparent to the originating or receiving user; in like manner, the storage and retrieval of fragments from another user's storage device should be transparent to the other user.

As noted above, the number of redundant storage units for each fragment is a system-specific parameter, and will depend upon the types of users forming the shared-storage group. For example, if the sharing is among corporate entities, the availability of the individual storage units can be expected to be high, and perhaps only two or three copies need be stored. On the other hand, if the sharing is random, unrelated users, the likelihood that each user's device will be on-line and available may be substantially lower, and perhaps five to ten copies would need to be stored to provide reliable retrieval. Optionally, the availability of each user's storage unit(s) could be monitored and used to provide bonuses to each user, thereby providing an incentive for high availability among most storage units.

As is known in the art, the reading or writing of data to a large contiguous storage space is generally more efficient than multiple reads and writes to smaller independently accessible storage blocks. Although the invention is presented above using the paradigm of storing each fragment independently, one of skill in the art will recognize that multiple fragments that are allocated to contiguous storage units at a storage node may be sent as a single block of fragments to the storage node. In like manner, if the storage units are very large, and the storage node provides the allocation of fragments to specific memory locations within each storage unit, the transmission of a block of fragments will allow the storage node to place the fragments in contiguous locations to facilitate efficient retrieval. For example, if all of the segments of the file are configured to be stored at a particular storage node, the entire file can be sent, and the storage node will attempt to place the fragments in contiguous locations.

As files are modified or deleted, gaps in allocated contiguous storage blocks will appear, or, conversely, potentially available large blocks may be prevented by a few allocated storage units. In a preferred embodiment, periodic ‘garbage-collection’ or ‘de-fragmentation’ is preferably performed to reallocate fragments among storage units to avoid such gaps, particularly for files that have been dormant for a long period of time. To effect this de-fragmentation, the storage nodes are preferably configured to use an indirect address scheme to locally associate a memory location to each fragment, as discussed above with respect to the use of very large storage units. When a fragment is relocated, only the corresponding memory address in the storage unit's memory map is updated to reflect the new location.

As noted above, multiple redundant copies of each fragment of a user's file will be stored in the network. Preferably a scheme is provided to facilitate an efficient ‘clean up’ of files. For example, the service can be marketed as a temporary storage facility that only guarantees that the saved files will be available for a specified (or contracted) amount of time. In such an embodiment, the central storage controller is configured to identify files that have been stored for longer than the specified guarantee-time, and to delete/reallocate the storage units identified in the file tracker of the file. Such a scheme may be well suited for storing files that are subsequently made available to the user from a remote location, or for transmitting files to other users, but may not be suitable as a long-term back-up system. A hybrid scheme may be provided, wherein the user is able to explicitly identify the files that should not be deleted from the network. Alternatively, the system may be coupled to a conventional remote back-up facility, wherein files that are not accessed after a given time period are off-loaded to the conventional back-up facility, with a suitable update to each file's tracker and subsequent reallocation of the storage units. In such an embodiment, when and if the file is accessed from the conventional back-up facility, and subsequently changed, it is preferably saved to the shared-resource network as a ‘new’ file, as discussed above, and deleted from the conventional back-up facility. Thereafter, the file will be treated as any other file, and stored at the back-up facility after the above detailed dormancy period.

As noted above, the number of redundant storage units per fragment is dependent upon the expected availability of each storage node. The determination of the number of storage units per fragment can be dynamic. For example, if a particular node is known to be substantially continuously available, when a storage unit from that node is allocated to a fragment, the number of other storage units allocated to that fragment can be reduced. In an example embodiment, an availability measure may be associated with each storage unit, and storage units are allocated to each fragment until a given threshold of accumulated availability is reached for that fragment. In another embodiment, to provide a consistent allocation of storage units and a consistent structure of the file tracker, one or more ‘dummy’ storage units can be allocated whenever a known reliable storage unit is allocated. The allocated storage unit and dummy storage units will be associated with the same storage node; when a storage or retrieval request arrives for any of these storage units, the storage node will store or retrieve the fragment from a common storage unit.

In a system that includes a central server, the central server may also be a storage node, with one or more storage units. In such a system, the number of redundant storage nodes may be reduced, as noted above, because it is assumed that the central server is virtually always available. Although generally that allocation of storage units will be somewhat random or arbitrary, the central server may be selective with regard to the allocation of its storage units, to maintain overall system efficiency. For example, as discussed above, the system is particularly useful for the storage or transmission of large files; however, setting a minimum file-size limit on the use of the system would detract from its user-appeal, because a typical user will prefer a consistent method of storing and transmitting files regardless of their size. To provide a proper tradeoff between efficiency and user convenience, the central server in this embodiment could be configured to allocate its storage units to small files, and restrict/minimize the allocation of such small files to other storage nodes. That is, the central server can be configured to provide relatively conventional file storage capabilities for small files, and distributed file storage capabilities to large files. This conventional file storage capability may be apparent, via the allocation of a single storage unit for the file, or transparent, using, for example, ‘dummy’ storage units, as discussed above.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

We claim:

1. A method comprising:
segmenting a file into a plurality of fragments at a local node,
storing each fragment at a plurality of remote storage nodes on a network, each storage node including one or more storage units, and
creating a file tracker that identifies the storage units at which each fragment is stored to facilitate retrieval of each fragment from one of the one or more storage units.

2. The method of claim 1, wherein
the file tracker includes revision data associated with each fragment, to facilitate selective retrieval of one or more fragments based on the revision data.

3. The method of claim 2, including
compacting the file tracker.

4. The method of claim 1, including
compacting the file tracker.

5. The method of claim 1, wherein
storing each fragment at the plurality of remote storage nodes includes transmitting the fragment and a storage unit list from the local node to a first node of the plurality of remote storage nodes,
wherein the storage unit list provides identification at least a second node of the plurality of remote storage nodes for the fragment, to facilitate transmission of the fragment from the first storage node to the second storage node.

6. The method of claim 1, including
storing the file and the file tracker at the local node.

7. The method of claim 1, including
transmitting the file tracker to an intended recipient of the file.

8. The method of claim 1, including
transmitting the file tracker to a central server, to facilitate access to the file tracker from remote nodes.

9. The method of claim 1, including
obtaining identification of a set of storage units from a central server that is configured to manage allocation of storage units,
wherein the storage units at which the fragments are stored are selected from the set of storage units obtained from the central server.

10. The method of claim 1, including
encrypting each fragment.

11. The method of claim 1, including at least one of:
compacting the file, and
compacting each fragment.

12. The method of claim 1, wherein
each storage unit has a size of at least 100 MB, and
each fragment has a size of not more than 1 MB.

13. The method of claim 1, including
storing revision information corresponding to each fragment in the file tracker.

14. A method comprising:
accessing a file tracker that identifies a plurality of remote storage units associated with each fragment of one or more fragments of a file;
for each fragment:
selecting a storage unit from the plurality of remote storage units associated with the fragment,
retrieving the fragment from the storage unit; and
arranging the one or more fragments to create the file.

15. The method of claim 14, wherein
each fragment is stored in a compacted form at the plurality of remote storage units, and
the method includes de-compacting the compacted form of each fragment.

16. The method of claim 14, wherein
each fragment is stored in an encrypted form at the plurality of remote storage units, and
the method includes decrypting the encrypted form of each fragment.

17. The method of claim 14, including
retrieving the file tracker from a central server.

18. The method of claim 14, including
receiving the file tracker from an originator of the file tracker.

19. The method of claim 14, including
accessing revision information in the file tracker, and
selectively retrieving each fragment based on the revision information.

20. A method comprising:
maintaining a database of distributed storage units that includes an identification of an amount of space available at each storage unit,
receiving a request for identification of a plurality of storage units from a remote node, the request including a space requirement,
selecting the plurality of storage units from the distributed storage units based on the space requirement and the amount of space available at each of the plurality t of storage units,
transmitting the identification of the plurality of storage units to the remote node, and
updating the identification of the amount of space available at each of the plurality of storage units based on the space requirement.

21. The method of claim 20, wherein
the identification of the plurality of storage units includes a URL associated with each of the plurality of storage units.

22. The method of claim 20, including
receiving a file tracker that identifies the plurality of storage units that contain one or more fragments of a file.

23. The method of claim 20, including
receiving a request to release storage, the request including an identification of the plurality of storage units that contain one or more fragments of a file,
transmitting an instruction to each of the plurality of storage units to release the storage at the storage unit corresponding to the one or more fragments of the file, and
updating the identification of the amount of space available at each of the plurality of storage units based on the storage that is released.

24. The method of claim 23, wherein
the identification of the plurality of storage units includes an identification of a file tracker that contains the identification of the plurality of storage units that contain the one or more fragments of the file.

25. The method of claim 23, including
determining an elapsed time since transmitting the identification of the plurality of storage units, and
generating the request to release storage based on the elapsed time.

26. The method of claim 20, including
creating the database of distributed storage units.

27. The method of claim 26, including
soliciting users to provide storage units to form the distributed storage units.

28. The method of claim 27, including
receiving the request for identification of the plurality of storage units from the remote node includes verification that the remote node is associated with a user that has provided one or more storage units.

29. A computer program stored on a computer readable media that, when executed on a processing system, causes the processing to:
segment a file into a plurality of fragments at a local node,
store each fragment at a plurality of remote storage nodes on a network, each storage node including one or more storage units, and
create a file tracker that identifies the storage units at which each fragment is stored to facilitate retrieval of each fragment from one of the one or more storage units.

30. The program of claim 29, wherein
the file tracker includes revision data associated with each fragment, to facilitate selective retrieval of one or more fragments based on the revision data.

31. The program of claim 29, wherein the computer program causes the processing system to
obtain identification of a set of storage units from a central server that is configured to manage allocation of storage units,
wherein the storage units at which the fragments are stored are selected from the set of storage units obtained from the central server.

32. The program of claim 29, wherein the computer program causes the processing system to encrypt each fragment.

33. A computer program stored on a computer readable media that, when executed on a processing system, causes the processing to:
access a file tracker that identifies a plurality of remote storage units associated with each fragment of one or more fragments of a file;
for each fragment:
select a storage unit from the plurality of remote storage units associated with the fragment,
retrieve the fragment from the storage unit; and
arrange the one or more fragments to create the file.

34. The computer program of claim 33, wherein
each fragment is stored in an encrypted form at the plurality of remote storage units, and
the computer program causes the processing system to decrypt the encrypted form of each fragment.

35. The computer program of claim 33, wherein the computer program causes the processing system to:
access revision information in the file tracker, and
selectively retrieve each fragment based on the revision information.

36. A computer program stored on a computer readable media that, when executed on a processing system, causes the processing to:
maintain a database of distributed storage units that includes an identification of an amount of space available at each storage unit,
receive a request for identification of a plurality of storage units from a remote node, the request including a space requirement,
select the plurality of storage units from the distributed storage units based on the space requirement and the amount of space available at each of the plurality t of storage units,
transmit the identification of the plurality of storage units to the remote node, and
update the identification of the amount of space available at each of the plurality of storage units based on the space requirement.

37. The computer program of claim 36, wherein the computer program causes the processing system to:
receive a request to release storage, the request including an identification of the plurality of storage units that contain one or more fragments of a file,
transmit an instruction to each of the plurality of storage units to release the storage at the storage unit corresponding to the one or more fragments of the file, and
update the identification of the amount of space available at each of the plurality of storage units based on the storage that is released.

38. The computer program of claim 37, wherein the computer program causes the processing system to:
determine an elapsed time since transmitting the identification of the plurality of storage units, and
generate the request to release storage based on the elapsed time.

39. A system comprising:
a sending node that is configured to:
transmit fragments of a file for storage at a plurality of remote storage nodes, and
provide a file tracker that identifies a set of storage units at which each fragment is stored at the remote storage nodes, and
a receiving node that is configured to:
receive the file tracker, and,
based on the file tracker,
retrieve each fragment from a storage unit of the set of storage units at which the fragment is stored, and
provide therefrom a copy of the file.

40. The system of claim 39, including
a server that is configured to communicate an identification of the storage units to the sending node.

41. The system of claim 40, wherein
the server is configured to provide an identification of the remote storage nodes corresponding to the storage units to the receiving node.

42. The system of claim 41, wherein
the server includes at least one storage unit.

43. The system of claim 42, wherein
the server communicates an identification of the storage unit at the server to the sending unit based on a size of the file.

44. The system of claim 39, including
the plurality of storage nodes.

45. The system of claim 39, wherein
the sending node is configured to transmit each fragment to a select storage unit of the set of storage units with an identification of at least one other storage unit of the set of storage units, to facilitate transmission of the fragment to the other storage unit from the select storage unit.

46. The system of claim 39, wherein
the sending node is configured to encrypt the fragments.

47. The system of claim 39, wherein
the sending node is configured to compact at least part of the file tracker.

48. The system of claim 39, wherein
the sending unit includes one or more other storage units that are configured to receive fragments of other files from one or more remote sources.

49. The system of claim 39, wherein
the receiving unit includes one or more other storage units that are configured to receive fragments of other files from one or more remote sources.

50. A processing system comprising:
a segmenter that is configured to segment a file into a plurality of fragments,
an allocation that is configured to:
allocate a plurality of storage units at a plurality of remote storage nodes to each fragment of the plurality of fragments, and
create a file tracker that identifies the plurality of storage units allocated to each fragment, and
a controller that is configured to transmit each fragment for storage at each of the plurality of storage units allocated to the fragment.

51. The processing system of claim 50, including
an encrytor that is configured to encrypt at least a part of at least one fragment.

52. The processing system of claim 50, wherein
the controller is configured to transmit the file tracker to an intended receiver of the file.

53. The processing system of claim 50, wherein
the controller is configured to receive an identification of the plurality of storage units from a remote server.

54. The processing system of claim 50, wherein
the controller is configured to compact at least a part of the file tracker.

55. The processing system of claim 50, wherein
the controller is configured to transmit each fragment for storage at each of the plurality of storage units by transmitting the fragment and an identification of an other storage unit of the plurality of storage units to a select storage node of the plurality of storage nodes, to facilitate transmission of the fragment to the other storage unit from the select storage unit.

56. The processing system of claim 50, including
one or more other storage units that are configured to receive fragments of other files from one or more remote sources.

57. A processing system comprising:
a controller that is configured to access a file tracker that identifies a plurality of storage units at which each fragment of a plurality of fragments of a file is stored,
a gatherer that is configured to retrieve each fragment of the plurality of fragments from a select one of the plurality of storage units at which the fragment is stored, and
a collator that is configured to arrange the fragments so as to provide a copy of the file.

58. The processing system of claim 57, including
a decryptor that is configured to decrypt one or more of the fragments.

59. The processing system of claim 57, wherein
the controller is configured to receive the file tracker from a remote source of the file.

60. The processing system of claim 57, wherein
the gatherer is configured to obtain an address corresponding to each storage unit from a remote server.

61. The processing system of claim 57, including
one or more other storage units that are configured to receive fragments of other files from one or more remote sources.

62. A server comprising:
a database that is configured to maintain a record of remote storage units at which file fragments may be stored, and
an allocator that is configured to:
receive a request for an identification of a set of storage units for storing a file,
provide an allocation of the remote storage units based on a size of the file and the record of remote storage units,
transmit the identification of the set of storage units based on the allocation, and
update the record of remote storage units based on the allocation.

63. The server of claim 62, including
one or more local storage units, wherein
the database is configured to maintain a record of the local storage units at which the file fragments may be stored, and
the allocator is configured to:
receive an other request for identification for an other set of storage units for storing an other file,
provide an other allocation of the local storage units based on a size of the other file and the record of local storage units,
transmit the identification of the other set of storage units based on the other allocation, and
update the record of local storage units based on the other allocation.

64. The server of claim 62, wherein
the allocator is configured to verify that the request for identification of the set of storage units is from a user that provides one or more of the remote storage units.

65. The server of claim 62, wherein
the allocator is configured to:
receive a request to de-allocate storage at the remote storage units based on the allocation,
transmit a release request to each of the storage units identified in the allocation, and
update the record of remote storage units to identify availability of storage for fragments of other files based on the allocation.
